(19) United States
(12) Patent Application Publication
(10) Pub. No.: US 2026/0369920 A1
(43) Pub. Date: Nov. 19, 2026

(54) CONNECTOR DEVICE

(71) Applicant: SUMITOMO WIRING SYSTEMS, LTD., Mie (JP)

(72) Inventor: Kazuya KOBAYASHI, Mie (JP)

(21) Appl. No.: 19/677,750

(22) Filed: May 14, 2026

(30) Foreign Application Priority Data
May 19, 2025 (JP) 2025-083022

(51) Int. Cl. H01R 13/518; H01R 12/72

(52) U.S. Cl. CPC H01R 13/518; H01R 12/722

(57) ABSTRACT

A connector device includes a frame made of resin and including an accommodation space and a connector to be arranged in the accommodation space. The connector includes an outer conductor made of metal. The outer conductor includes a press-fitting portion and is arranged on an upper surface of a board. The frame includes a press-fit portion in an inner surface of the accommodation space, the press-fitting portion being press-fit into the press-fit portion. The press-fit portion is provided in a lower part below a center in a vertical direction of the frame and not provided in an upper part.

### CROSS-REFERENCE TO RELATED APPLICATIONS

This application is based on and claims priority from Japanese Patent Application No. 2025-083022, filed on May 19, 2025 with the Japan Patent Office, the disclosure of which is incorporated herein in its entirety by reference.

### TECHNICAL FIELD

The present invention relates to a connector device.

### BACKGROUND

Japanese Patent Laid-open Publication No. 2024-168210 discloses a technique for assembling an outer conductor made of metal with a housing (can also be called a frame) made of resin. The outer conductor is mounted on a surface (upper surface) of a board. The housing and the outer conductor include a plurality of press-fitting parts to be press-fit to each other, and an assembled state thereof is maintained by the respective press-fitting parts. For example, the press-fitting part is constituted by a biting part of a contact portion of a hooking portion of the outer conductor into the front surface of a hooked portion of the housing. A technique for assembling an outer conductor with a housing is also disclosed in Japanese Patent Laid-open Publication No. 2023-111009.

### SUMMARY

In Japanese Patent Laid-open Publication No. 2024-168210, if an upper end part of the housing is provided with a rib or a wall extending in a lateral direction while including the hooked portion, the upper end part of the housing may be warped and deformed in a vertical direction due to a difference in heat shrinkage rate between the base end and the tip of the rib or the wall during the molding of the housing. In the case of Japanese Patent Laid-open Publication No. 2024-168210, the hooked portion is configured as the press-fitting part of the housing and the outer conductor. Thus, if the upper end part of the housing is warped and deformed, the height position of the press-fitting part of the outer conductor also changes and it may not be possible to install the outer conductor in a proper state on the upper surface of the board.

Accordingly, the present disclosure aims to provide a connector device enabling an outer conductor to be arranged at a proper position on the upper surface of a board.

The present disclosure is directed to a connector device with a frame made of resin and including an accommodation space, and a connector to be arranged in the accommodation space, the connector including an outer conductor made of metal, the outer conductor including a press-fitting portion, the outer conductor being arranged on an upper surface of a board, the frame including a press-fit portion in an inner surface of the accommodation space, the press-fitting portion being press-fit into the press-fit portion, and the press-fit portion being provided in a lower part below a center in a vertical direction of the frame and not provided in an upper part.

According to the present disclosure, it is possible to provide a connector device enabling an outer conductor to be arranged at a proper position on the upper surface of a board.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a back view showing a state where a connector device of one embodiment is mounted on a board.

FIG. 2 is a front view showing the state where the connector device of the embodiment is mounted on the board.

FIG. 3 is an exploded perspective view of a connector in the connector device of the embodiment.

FIG. 4 is a front view of a frame in the connector device of the embodiment.

FIG. 5 is a front view of an outer conductor of the connector in the connector device of the embodiment.

FIG. 6 is a plan view of the outer conductor of the connector in the connector device of the embodiment.

FIG. 7 is a bottom view of the outer conductor of the connector in the connector device of the embodiment.

FIG. 8 is a perspective view of an outer conductor of another connector in the connector device of the embodiment when viewed from front.

FIG. 9 is a side view in section of the connector device of the embodiment showing a state while the connector is being accommodated into an accommodation space of the frame in two-dot chain lines.

FIG. 10 is a plan view in section of the connector device of the embodiment showing a state where press-fitting portions of the outer conductor of the connector are press-fit in press-fit portions of the frame.

FIG. 11 is a side view in section of the connector device of the embodiment showing the state where the press-fitting portions of the outer conductor of the connector are press-fit in the press-fit portions of the frame.

FIG. 12 is a side view in section of the connector device of the embodiment showing a state where a hooking portion of the outer conductor of the connector is locked to a hooked portion of the frame.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

(1) The connector device of the present disclosure is provided with a frame made of resin and including an accommodation space, and a connector to be arranged in the accommodation space, the connector including an outer conductor made of metal, the outer conductor including a press-fitting portion, the outer conductor being arranged on an upper surface of a board, the frame including a press-fit portion in an inner surface of the accommodation space, the press-fitting portion being press-fit into the press-fit portion, and the press-fit portion being provided in a lower part below a center in a vertical direction of the frame and not provided in an upper part.

By press-fitting the press-fitting portion of the outer conductor into the press-fit portion of the frame, the outer conductor and the frame are held in an assembled state. Since the press-fit portion is provided in the lower part capable of suppressing warping deformation during the molding of the frame, the height position of the outer conductor in the vertical direction in mounting can be kept. As a result, the height position of the outer conductor can also be kept, and the outer conductor can be arranged at a proper position on the upper surface of the board.

(2) Preferably, in the connector device of (1) described above, the inner surface of the accommodation space has inner side surfaces facing each other in a lateral direction, and the press-fit portion is provided in the inner side surface and a press-fitting margin of the press-fit portion and the press-fitting portion is provided in the lateral direction.

The press-fitting margin of the press-fit portion and the press-fitting portion is provided in the lateral direction. This is preferable in view of the assemblability of the outer conductor.

(3) In the connector device of (1) or (2) described above, a plurality of the accommodation spaces may be provided in the frame, a plurality of types of the connectors including differently shaped outer conductors may be provided, the press-fitting portion may be provided to have the same shape at the same position in each of the plurality of types of connectors, and the press-fit portion may be provided to have the same shape at the same position in each of the plurality of accommodation spaces.

According to the configuration of (3) described above, even if the arbitrary connector selected from the plurality of types of connectors is accommodated into any one of the accommodation spaces of the frame, the press-fitting portion can be press-fit into the press-fit portion. Thus, a variation of forms of use can be expanded.

(4) Preferably, in the connector device of any one of (1) to (3) described above, each of the frame and the outer conductor is fixed to the board.

With the frame and the outer conductor fixed to the board, a relative positional relationship of the frame and the outer conductor is determined via the board. As a result, the rattling of the outer conductor with respect to the frame can be prevented.

### Details of Embodiment of Present Disclosure

A specific example of the present disclosure is described below with reference to the drawings. Note that the present invention is not limited to these illustrations, but is represented by claims and intended to include all changes in the scope of claims and in the meaning and scope of equivalents.

### Embodiment

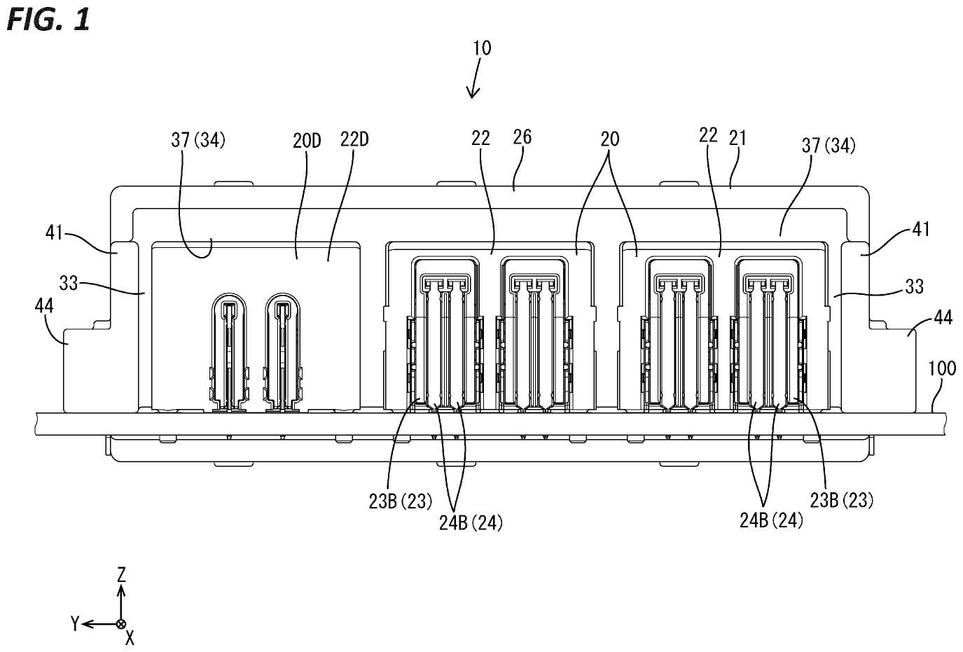

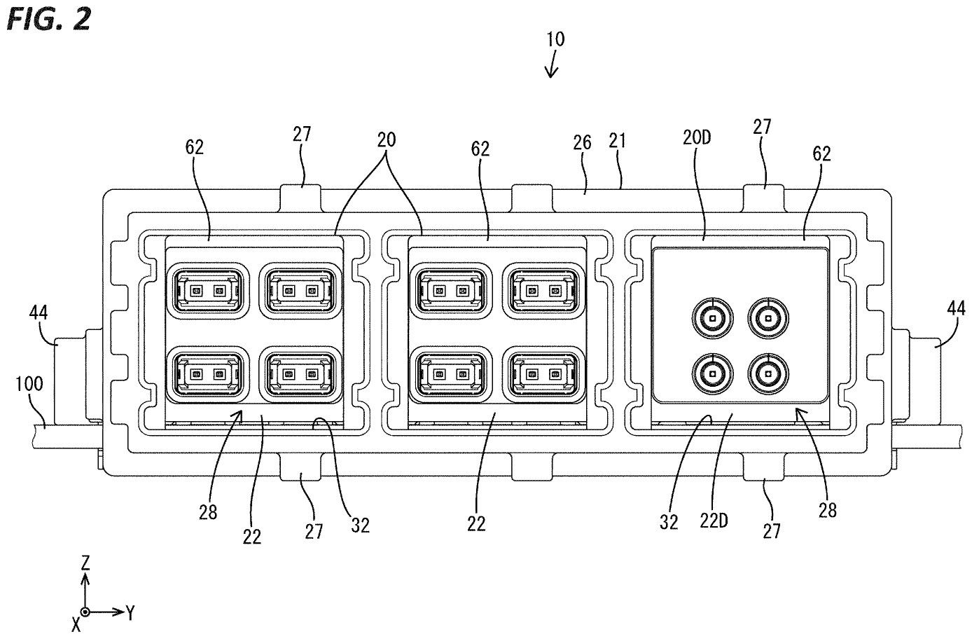

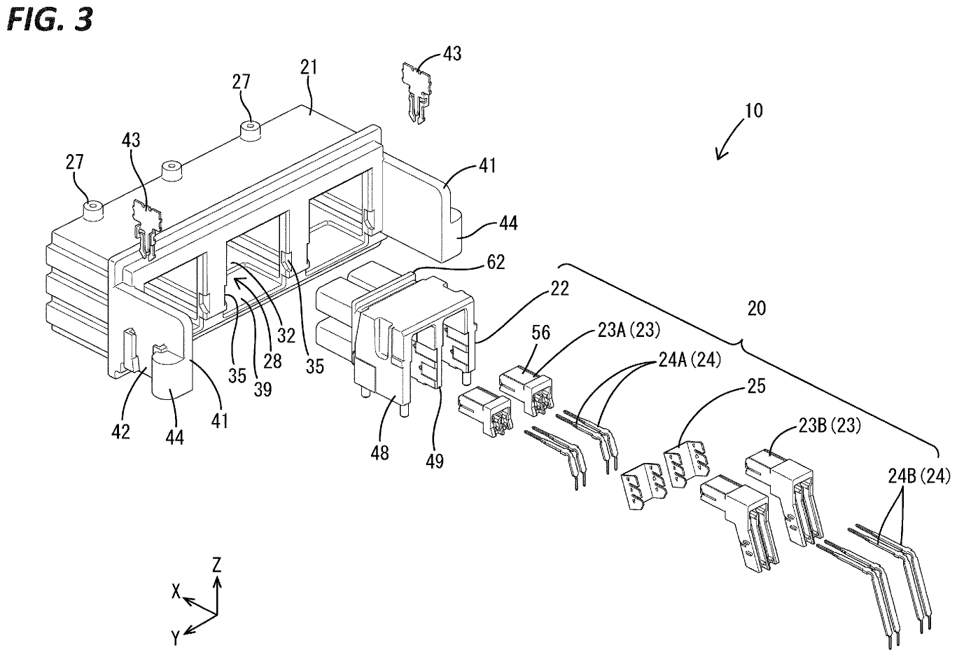

A connector 10 of one embodiment of the present disclosure is provided with a plurality of connectors 20 and a frame 21 for accommodating the respective connectors 20 as shown in FIGS. 1 and 2. The connector device 10 is installed on a surface of a board 100. The board 100 is a rigid circuit board. Each connector 20 is connected to an unillustrated mating connector while being accommodated in the frame 21. As shown in FIG. 3, the connector 20 includes an outer conductor 22, a plurality of dielectrics 23, a plurality of inner conductors 24 and a plurality of shielding members 25. As shown in FIGS. 1 and 2, another connector 20D of a different type is also accommodated into the frame 21, in addition to the connectors 20. In the following description, a connection direction of the connectors 20 and the other connector 20D to the corresponding mating connectors is referred to as a forward direction concerning a front-rear direction. A direction from the back surface to the front surface of the board 100 is referred to as an upward direction concerning a vertical direction. In FIGS. 1 to 3, X, Y and Z respectively represent a front side, a right side and an upper side. Direction references are for convenience and do not necessarily coincide with direction references in a state where the connector device 10 is installed in an unillustrated vehicle or the like.

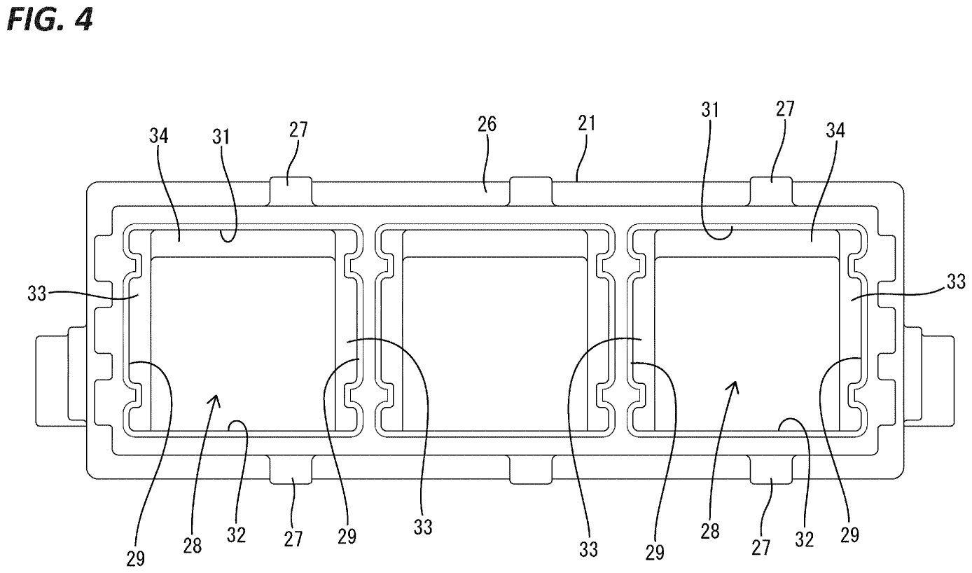

The frame 21 is made of synthetic resin. As shown in FIGS. 3 and 4, the frame 21 includes a frame body 26 in the form of a rectangular frame longer in the lateral direction than in the vertical direction.

A plurality of cam pins 27 project in the vertical direction on the frame body 26. Each cam pin 27 has a cylindrical shape. In the case of this embodiment, three cam pins 27 are provided side by side at intervals in the lateral direction on each of the upper surface of the upper wall and the lower surface of the lower wall of the frame body 26. Each cam pin 27 has a function of advancing the connection of the connectors 20 and the other connector 20D to the corresponding mating connectors by being engaged with levers of the unillustrated mating connectors.

The frame body 26 includes a plurality of accommodation spaces 28. In the case of this embodiment, three accommodation spaces 28 are provided side by side at intervals in the lateral direction at positions corresponding to the respective cam pins 27 on the frame body 26. As shown in FIG. 2, the connectors 20 and the other connector 20D are inserted and accommodated into the respective accommodation spaces 28. In the case of this embodiment, the connectors 20 are respectively accommodated into the accommodation spaces 28 in a left end part and a middle when viewed from front, and the other connector 20D is accommodated into the accommodation space in a right end part.

Each accommodation space 28 is in the shape of a rectangular opening in a front or back view. As shown in FIG. 4, the inner surface of each accommodation space 28 of the frame body 26 is composed of a pair of inner side surfaces 29 facing each other in the lateral direction and a pair of an inner upper surface 31 and an inner lower surface 32 facing each other in the vertical direction. The frame body 26 includes a pair of left and right first wall portions 33 extending in the vertical direction in a rear end part of each inner side surface 29 and a pair of second wall portions 34 extending in the lateral direction in rear end parts of the inner upper surfaces 31. An opening width in the lateral direction of the accommodation space 28 is narrowed by the respective first wall portions 33. In the case of this embodiment, the first wall portions 33 can also be called partition walls. An opening height in the vertical direction of the accommodation space 28 is narrowed by the second wall portion 34. Upper end parts of the pair of left and right first wall portions 33 are coupled to end parts on both left and right sides of the second wall portion 34.

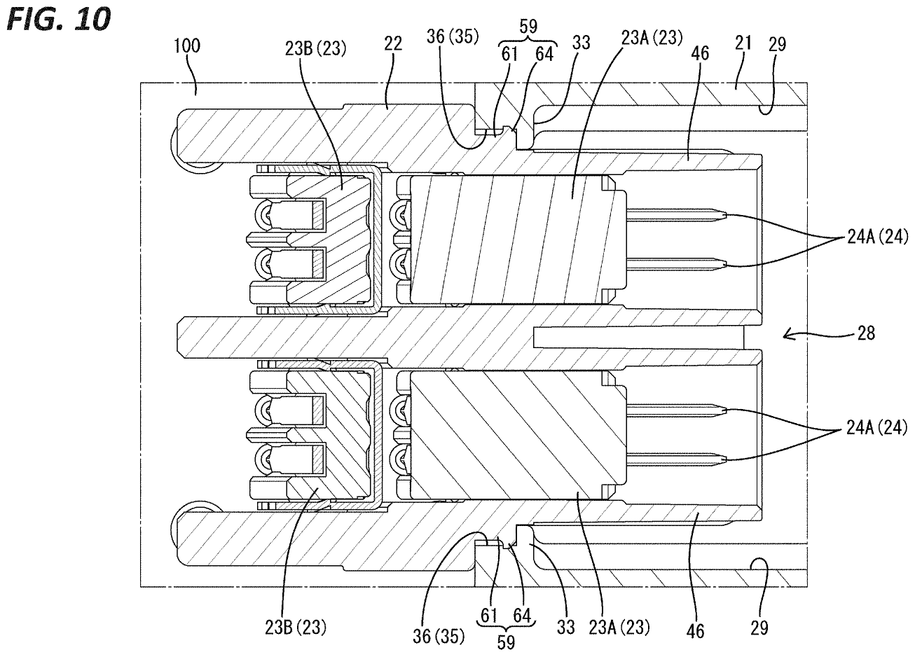

As shown in FIG. 3, a plurality of press-fit portions 35 paired in the lateral direction are provided on the inner surface of each accommodation space 28 of the frame body 26. As shown in FIG. 10, the respective press-fit portions 35 are provided by recessing the left and right inner surfaces (surfaces facing each other in the lateral direction) of the respective first wall portions 33, and facing the accommodation space 28. As shown in FIG. 3, the respective press-fit portions 35 are arranged in a lower part below a center in the vertical direction of the frame 21.

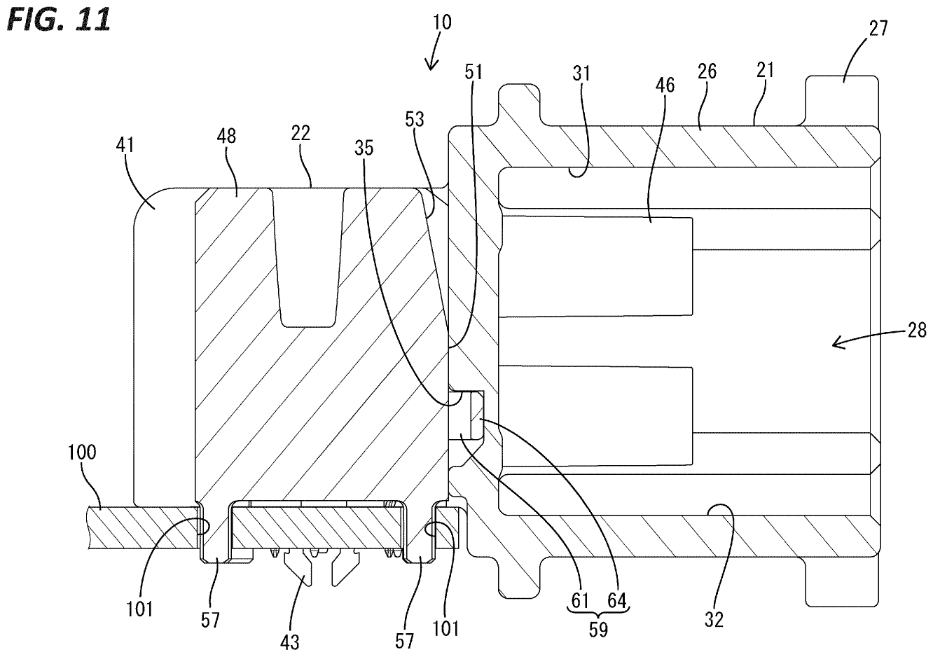

As shown in FIG. 10, the back surface (surface facing in the lateral direction) of the press-fit portions 35 is configured as a press-fit surface 36 along the vertical direction and the front-rear direction. The press-fit portion 35 is open rearward of the first wall portion 33 (frame body 26). The front end surface (end surface facing rearward) of the press-fit portion 35 is arranged along the vertical direction and the lateral direction. The upper end surface (end surface facing downward) of the press-fit portion 35 is arranged along the front-rear direction and the lateral direction. As shown in FIG. 11, the lower end surface (end surface facing upward) of the press-fit portion 35 has a part inclined downward toward a rear side. An opening height in the vertical direction from the upper end surface to the lower end surface of the press-fit portion 35 increases toward the rear side in the inclined part of the lower end surface. A later-described press-fitting portion 59 of the outer conductor 22 of the connector 20 is press-fit into the press-fit portion 35. In the case of this embodiment, the press-fit portion 35 can also be called a recess.

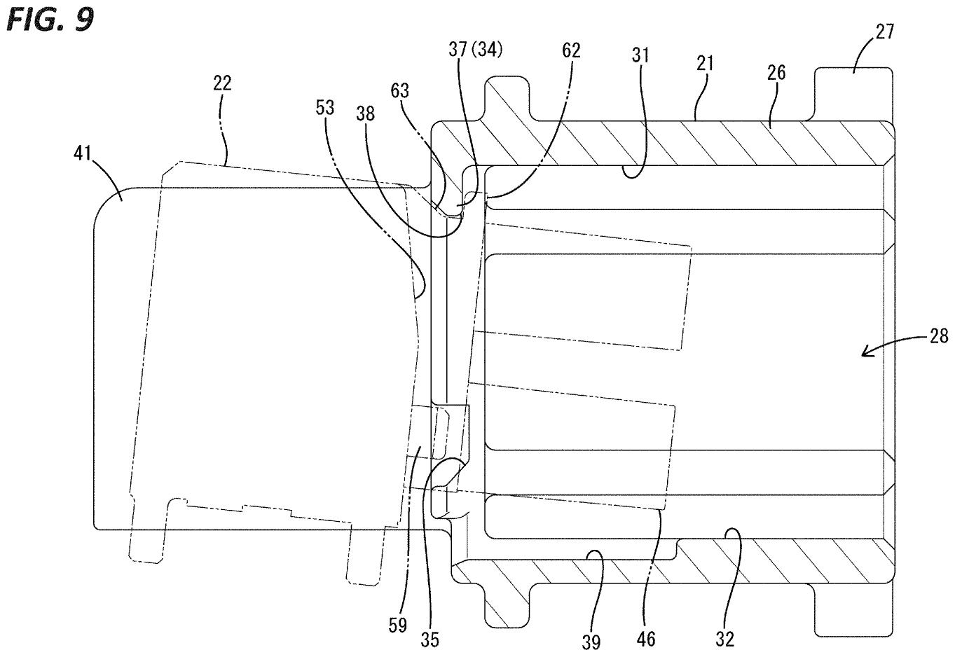

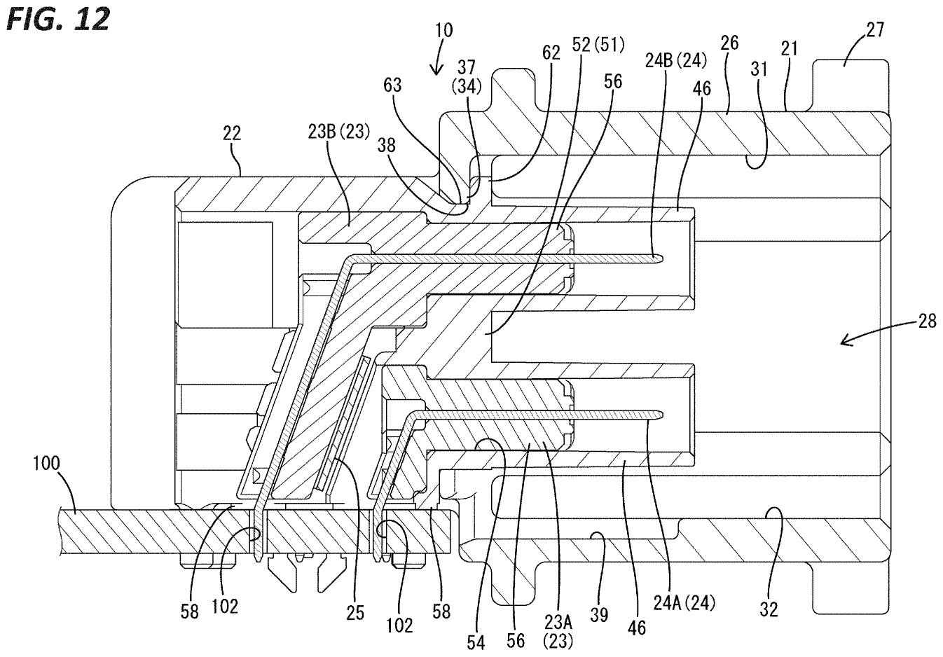

A hooked portion 37 is provided in an upper end part of each accommodation space 28 of the frame body 26. As shown in FIG. 9, the hooked portion 37 is constituted by a lower part of the second wall portion 34. The front end surface (surface facing forward) of the hooked portion 37 is arranged along the vertical direction and the lateral direction. The lower end surface (surface facing downward) of the hooked portion 37 is inclined upward toward the rear side from an arcuate curved surface portion 38 located on a front end part of that lower end surface. As shown in FIG. 12, a later-described hooking portion 62 of the outer conductor 22 of the connector 20 is hooked and locked to the hooked portion 37. Each hooked portion 37 is arranged in an upper part above the center in the vertical direction of the frame 21.

A recess 39 is provided in a lower end part of each accommodation space 28 of the frame body 26. As shown in FIGS. 3 and 9, the recess 39 is shallowly recessed in the inner lower surface 32 of the accommodation space 28. An opening width in the lateral direction of the recess 39 is equal to a distance between the left and right inner surfaces of the first wall portions 33 on the respective inner side surfaces 29. The recess 39 is open rearward of the frame body 26. Note that, in each accommodation space 28 of the frame 21, the shapes and relative positional relationship of the press-fit portion 35 and the hooked portion 37 are the same.

As shown in FIG. 3, the frame 21 includes a pair of protection wall portions 41 projecting rearward from end parts on both left and right sides of the frame body 26. The respective protection wall portions 41 are arranged to cover the respective connectors 20 accommodated in the respective accommodation spaces 28 of the frame body 26 from outside laterally. Mounting groove portions 42 are provided in left and right outer surfaces of lower parts of the respective protection wall portions 41. The mounting groove portion 42 is open upward and downward. A fixing member 43 is press-fit and mounted into the mounting groove portion 42 of each protection wall portion 41 from above. The fixing member 43 is a plate member made of metal and plate surfaces thereof are facing in the lateral direction. An upper part of the fixing member 43 is press-fit into the mounting groove portion 42. A lower part of the fixing member 43 is inserted into an unillustrated frame fixing hole and soldered and fixed to the board 100.

As shown in FIG. 3, screwing portions 44 are provided to project on left and right outer surfaces of rear lower parts of the respective protection wall portions 41. The screwing portion 44 has an outer shape extending in the vertical direction and having a semicircular cross-section. The screwing portions 44 are placed on the upper surface of the board 100. Unillustrated screws are screwed into the screwing portions 44 across the board 100.

As described above, the second wall portion 34 including the hooked portion 37 is provided in the upper end part of each accommodation space 28 of the frame 21. When the frame 21 is molded, the upper end part of the frame 21 tends to be easily warped and deformed in the vertical direction due to a difference in shrinkage rate between the base end (part coupled to the inner upper surface 31) and the tip of the second wall portion 34. In contrast, a lower end part of the frame 21 including the inner lower surfaces 32 is not provided with a rib or a wall. Thus, the warping deformation of the lower end part of the frame 21 tends to be suppressed to be small.

Next, the structure of each of the inner conductors 24, the dielectrics 23, the shielding members 25 and the outer conductor 22 constituting the connector 20 is configured. The inner conductor 24 is made of electrically conductive metal and pin-like or tab-like. As shown in FIG. 3, the inner conductor 24 is bent at an obtuse angle in a side view via a bent part at a midway position in an extension direction. In the case of this embodiment, the respective inner conductors 24 include a plurality of first inner conductors 24A and a plurality of second inner conductors 24B longer than the respective first inner conductors 24A. Two pairs of the first inner conductors 24A are provided in the lateral direction. Two pairs of the second inner conductors 24B are also provided in the lateral direction.

Each dielectric 23 is made of insulating resin. As shown in FIG. 3, the dielectric 23 is bent at an obtuse angle in a side view to correspond to the inner conductors 24. The respective dielectrics 23 include a plurality of first dielectrics 23A and a plurality of second dielectrics 23B larger in size than the respective first dielectrics 23A. A pair of the first dielectrics 23A are provided in the lateral direction. A pair of the second dielectrics 23B are also provided in the lateral direction. As shown in FIG. 12, the first inner conductors 24A are accommodated into the first dielectric 23A. The second inner conductors 24B are accommodated into the second dielectric 23B. The first dielectrics 23A are arranged in a front lower part of the outer conductor 22, together with the first inner conductors 24A. The second dielectrics 23B are arranged in a part of the outer conductor 22 including a front upper part, a rear upper part and a rear lower part, together with the second inner conductors 24B.

The shielding member 25 is a plate member made of electrically conductive metal. As shown in FIG. 3, a pair of the shielding members 25 are provided in the lateral direction. As shown in FIG. 12, the shielding member 25 is arranged between the first and second dielectrics 23A, 23B inside the outer conductor 22. The respective first inner conductors 24A accommodated in the first dielectric 23A and the respective second inner conductors 24B accommodated in the second dielectric 23B are shielded from each other by the shielding member 25.

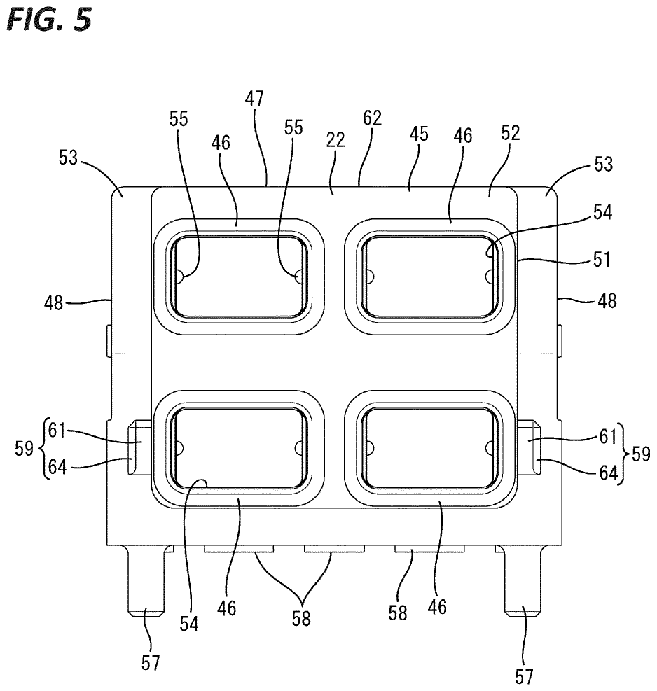

The outer conductor 22 is made of electrically conductive metal and configured as a cast product formed by die-casting zinc alloy, aluminum alloy or the like. As shown in FIGS. 5 to 7, the outer conductor 22 includes a body portion 45 and a plurality of tube portions 46 projecting forward from the body portion 45.

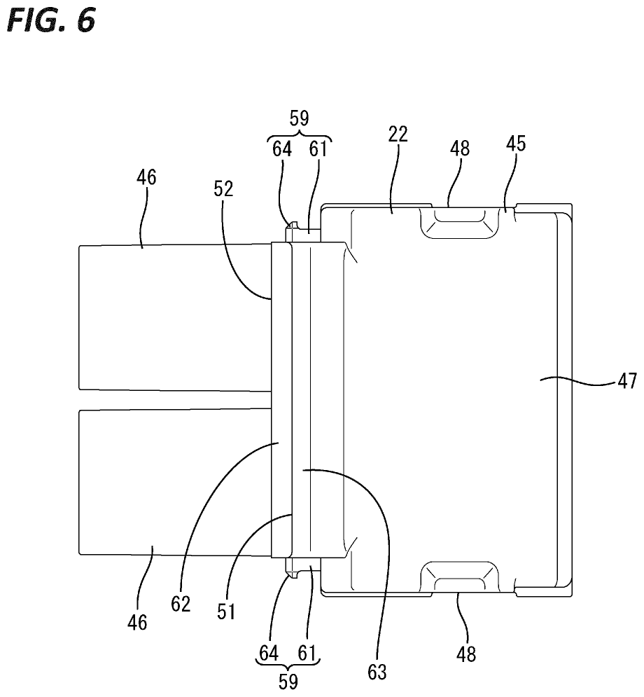

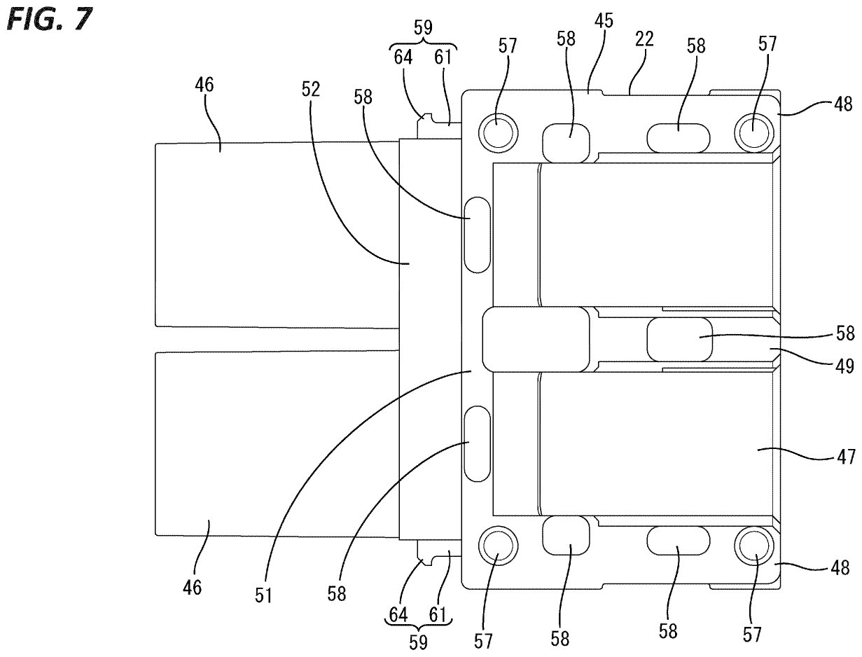

The body portion 45 includes an upper wall portion 47, a pair of left and right side wall portions 48, a separation wall portion 49 and a front wall portion 51. As shown in FIGS. 5 and 6, the upper wall portion 47 is arranged along the front-rear direction and the lateral direction with wall surfaces facing in the vertical direction. Each side wall portion 48 is arranged along the front-rear direction and the vertical direction with wall surfaces facing in the lateral direction. Upper end parts of the respective side wall portions 48 are coupled to end parts on both left and right sides of the upper wall portion 47. As shown in FIGS. 3 and 7, the separation wall portion 49 is arranged along the front-rear direction and the vertical direction with wall surfaces facing in the lateral direction. The separation wall portion 49 is arranged between the respective side wall portions 48 in the lateral direction. An upper end part of the separation wall portion 49 is coupled to a center in the lateral direction of the upper wall portion 47.

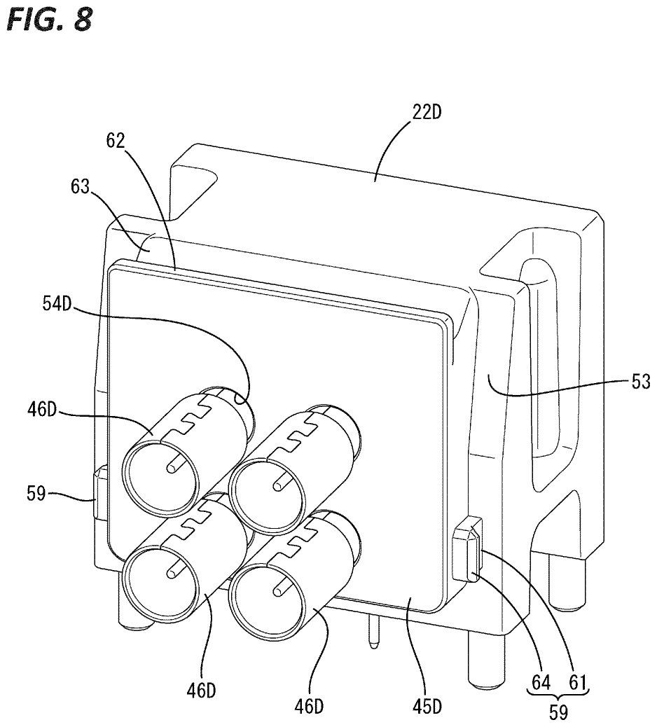

The wall surfaces of the front wall portion 51 are facing in the front-rear direction. As shown in FIGS. 5 to 7, the front wall portion 51 includes a projecting wall 52 formed to be thicker in the front-rear direction than end parts on both left and right sides and a lower end part thereof. Retracted slopes 53 inclined rearward toward an upper side are provided on upper parts of the front surfaces of the end parts on the both left and right sides of the front wall portion 51 as shown in FIGS. 8 and 9. When the outer conductor 22 is in an oblique posture in an initial stage of the insertion of the connector 20 into the accommodation space 28, the retracted slopes 53 are facing the second wall portion 34 of the frame 21 from behind while being spaced apart. In this way, a situation where an inserting operation into the accommodation space 28 is hindered due to the interference of the connector 20 with the frame 21 is avoided.

The upper end part of the front wall portion 51 is coupled to the front end part of the upper wall portion 47. The end parts on the both left and right sides of the front wall portion 51 are coupled to front end parts of the respective side wall portions 48. A center in the lateral direction of the front wall portion 51 is coupled to a front end part of the separation wall portion 49. As shown in FIG. 12, the front wall portion 51 includes a plurality of through holes 54 penetrating through the projecting wall 52 in the front-rear direction. As shown in FIG. 5, the respective through holes 54 are paired in each of the front-rear direction and the lateral direction, and a total of four through holes 54 are provided. Each through hole 54 is longer in the lateral direction than in the vertical direction and has a rectangular opening shape with four rounded corners.

Each tube portion 46 projects forward from the opening edge of each through hole 54 in the front surface of the projecting wall 52 of the front wall portion 51. The respective tube portions 46 are paired in each of the front-rear direction and the lateral direction to correspond to the respective through holes 54, and a total of four tube portions 46 are provided. The inside of each tube portion 46 communicates with each through hole 54. Each tube portion 46 is longer in the lateral direction than in the vertical direction and has a rectangular outer shape with four rounded corners.

As shown in FIG. 5, a pair of projections 55 facing each other in the lateral direction are provided on the inner surface of each tube portion 46. Each projection 55 has a curved projection shape. As shown in FIGS. 3 and 12, a part extending in the front-rear direction in the dielectric 23 (hereinafter, referred to as a “front-rear extending portion 56”) is inserted into the tube portion 46 through the through hole 54 from the inside of the body portion 45. In the case of this embodiment, the front-rear extending portions 56 of the second dielectrics 23B are inserted into the tube portions 46 paired in the lateral direction in an upper section of the front wall portion 51. The front-rear extending portions 56 of the first dielectrics 23A are inserted into the tube portions 46 paired in the lateral direction in a lower section of the front wall portion 51. The respective projections 55 of the tube portion 46 are locked to bite into the front-rear extending portion 56. In this way, each dielectric 23 is press-fit and held in the outer conductor 22.

The body portion 45 is provided with a plurality of leg portions 57. As shown in FIG. 7, the respective leg portions 57 project downward respectively from four corner parts on the bottom surfaces of the respective side wall portions 48 of the body portion 45. Each leg portion 57 has a cylindrical shape. As shown in FIG. 11, each leg portion 57 is inserted into a corresponding outer conductor fixing hole 101 of the board 100 and soldered and connected. As shown in FIG. 7, a plurality of mounting portions 58 are provided on the bottom surface of the body portion 45. Each mounting portion 58 is in the form of a flat base projecting on the bottom surface of the body portion 45. The respective mounting portions 58 are arranged at intervals on the bottom surface of each of the side wall portions 48, the separation wall portion 49 and the front wall portion 51. The lower surface (tip surface in a projection direction) of each mounting portion 58 is formed to be flat along the front-rear direction and the lateral direction. As shown in FIG. 12, the lower surface of each mounting portion 58 is arranged to be able to contact the upper surface of the board 100. By arranging the lower surfaces of the respective mounting portions 58 to be able to contact the upper surface of the board 100, the outer conductor 22 is arranged at a proper height position with respect to the board 100.

As shown in FIGS. 5 to 7, a plurality of the press-fitting portions 59 are provided on end parts on the both left and right sides of the outer conductor 22. In the case of this embodiment, the respective press-fitting portions 59 are paired and project laterally outward from lower end parts of the end surfaces on both left and right sides of the projecting wall 52 of the front wall portion 51. As shown in FIG. 5, the respective press-fitting portions 59 are arranged in a lower part below a center in the vertical direction of the outer conductor 22.

Each press-fitting portion 59 includes a base portion 61 in the form of a rectangular block longer in the vertical direction than in the front-rear direction. As shown in FIGS. 6 and 7, rear end parts of the base portions 61 are coupled to lower parts of the front surfaces of the end parts on the both left and right sides of the front wall portion 51. As shown in FIG. 11, with the press-fitting portion 59 press-fit in the press-fit portion 35, the front end surface of the base portion 61 and the front end surface (surface facing rearward) of the press-fit portion 35 are facing to be able to contact each other, and the upper end surface of the base portion 61 and the upper end surface (surface facing downward) of the press-fit portion 35 are facing to be able to contact each other.

As shown in FIGS. 5 to 7, each press-fitting portion 59 includes a press-fitting projection 64 projecting laterally outward from a front end part of the base portion 61. As shown in FIG. 11, the press-fitting projection 64 is in the form of a rib extending in the vertical direction along the front end part of the base portion 61. As shown in FIGS. 5 and 6, the front surface of the press-fitting projection 64 is inclined rearward toward a laterally outer side. The rear surface of the press-fitting projection 64 is arranged along the vertical direction and the lateral direction. The press-fitting projection 64 of each press-fitting portion 59 is locked to bite into the press-fit surface 36 of each press-fit portion 35. By locking the press-fitting projection 64 to the press-fit portion 35, the press-fitting portion 59 is press-fit into the press-fit portion 35 and that press-fit state can be maintained.

As shown in FIGS. 3, 5 and 6, the hooking portion 62 is provided in the upper end part of the outer conductor 22. In the case of this embodiment, the hooking portion 62 is configured in the shape of a wall extending in the lateral direction in a front end part of the upper end surface of the projecting wall 52 of the front wall portion 51. The hooking portion 62 is arranged in an upper part above the center in the vertical direction of the outer conductor 22. The hooking portion 62 is provided over the entire width in the lateral direction of the projecting wall 52. The front and rear end surfaces of the hooking portion 62 are arranged along the vertical direction and the lateral direction. The upper end surface of the hooking portion 62 is arranged along the front-rear direction and the lateral direction. As shown in FIG. 12, the rear end surface of the hooking portion 62 is facing to be able to contact the front end surface of the hooked portion 37, whereby the hooking portion 62 is locked to the hooked portion 37 and that locked state can be maintained. With the hooking portion 62 locked to the hooked portion 37, the upper end surface of the hooking portion 62 is arranged below and away from the inner upper surface 31 of the accommodation space 28.

A recessed surface portion 63 relatively recessed from the hooking portion 62 is provided behind the hooking portion 62 in the upper end surface of the projecting wall 52. The recessed surface portion 63 is inclined upward toward the rear side from the lower end of the rear end surface of the hooking portion 62. As shown in FIG. 12, with the hooking portion 62 locked to the hooked portion 37, the recessed surface portion 63 is facing an inclined part of the lower end surface of the hooked portion 37 and the hooked portion 37 is fit into a recessed part formed between the recessed surface portion 63 and the projecting wall 52.

The other connector 20D shown in FIG. 8 also includes inner conductors, dielectrics, shielding members and an outer conductor 22D although not shown in detail. The inner conductors, the dielectrics, the shielding members and the outer conductor 22D of the other connector 20D are different from those of the connector 20 in overall shape. In the outer conductor 22D, a body portion 45D and a plurality of tube portions 46D (four tube portions 46D) are configured as mutually separate bodies. The body portion 45D is configured as a cast produce by die-casting. Each tube portion 46D is a plate member made of electrically conductive metal and configured as a press-worked product. The tube portion 46D is inserted and mounted into a corresponding through hole 54D of the body portion 45D from front.

The other connector 20D includes the body portion 45D of the outer conductor 22D and a hooking portion 62 and a plurality of press-fitting portions 59. The shapes and formation positions (relative positions of the hooking portion 62 and each press-fitting portion 59) of the hooking portion 62 and the press-fitting portions 59 are the same between the other connector 20D and the connectors 20.

Next, an assembly procedure and functions of the connector device 10 of this embodiment are described.

In assembling the connector 20, the respective first dielectrics 23A, the respective shielding members 25 and the respective second dielectrics 23B are successively inserted and accommodated into the outer conductor 22. The respective first inner conductors 24A and the respective second inner conductors 24B are held in the respective first dielectrics 23A and the respective second dielectrics 23B in advance. With the connector 20 assembled, the front end part of each inner conductor 24 projects forward from the dielectric 23 and is arranged inside the tube portion 46 (see FIGS. 10 and 12). The lower end part of each inner conductor 24 projects downward from the dielectric 23 and the outer conductor 22.

Subsequently, the connector 20 is inserted into the accommodation space 28 of the frame 21 from behind while being in a posture inclined to a front rear side (see FIG. 9). At this time, the front end of each tube portion 46 can enter the recess 39 while facing downward. The lower end part of the press-fitting portion 59 can pass on the inclined lower end surface of the press-fit portion 35. Thus, a situation where the inserting operation of the connector 20 into the accommodation space 28 is hindered by interference with the frame 21 can be avoided.

Further, in an insertion process of the connector 20 into the accommodation space 28, the hooking portion 62 is moved (rotated) forward of the hooked portion 37 along the lower end surface of the hooked portion 37 and the inclined posture of the connector 20 is gradually eliminated. The curved surface portion 38 slides along the inclined part of the lower end surface of the hooked portion 37, whereby an operation of eliminating the inclined posture of the connector 20 (inserting operation) is guided.

If the connector 20 is inserted into the accommodation space 28, the press-fitting projection 64 of each press-fitting portion 59 is locked to bite into the press-fit surface 36 of each press-fit portion 35 (see FIG. 10), and the connector 20 is held in a predetermined posture (horizontal posture) with respect to the frame 21. Simultaneously, the hooked portion 37 is fit into the recessed part between the hooking portion 62 and the curved surface portion 38, the rear end surface of the hooking portion 62 is facing to be able to contact the front end surface of the hooked portion 37 (see FIG. 12) and the rearward escape of the connector 20 from the accommodation space 28 is hindered.

In the case of this embodiment, the press-fitting parts of the connector 20 and the frame 21 are limited to press-fitting parts of the respective press-fitting portions 59 and the respective press-fit portion 35. The respective press-fit portions 35 are provided in the lower part of the frame 21. Thus, even if the upper part of the frame 21 is warped and deformed during molding, a situation where the height positions in the vertical direction of the press-fitting parts of the respective press-fitting portions 59 and the respective press-fit portions 35 provided in the lower part of the frame 21 largely change can be suppressed. Note that each fixing portion 43 is mounted into each protection wall portion 41 of the frame 21 after or before the insertion of the connector 20 into the accommodation space 28.

The connector device 10 assembled as described above is placed on the upper surface of the board 100. The lower part of each fixing member 43 is inserted into each unillustrated frame fixing hole of the board 100. Each leg portion 57 is inserted into each outer conductor fixing hole 101 of the board 100 (see FIG. 11). The lower part of each inner conductor 24 is inserted into each through-hole 102 of the board 100 (see FIG. 12). Each mounting portion 58 is arranged along the upper surface of the board 100. In this state, reflow soldering is performed. Corresponding solder paste is melted by heating in a reflow furnace. After heating in the reflow furnace, the solder paste is solidified, each fixing member 43 is mechanically connected to the board 100 and each leg portion 57 is mechanically and electrically connected to the board 100. In this way, the frame 21 and the outer conductor 22 are fixed to the board 100. Each inner conductor 24 is also electrically connected to the board 100. Note that the upper part of the frame 21 is thermally expanded by heating in the reflow furnace and the warping deformation of the upper part of the frame 21 can be corrected.

As described above, the connector device 10 of this embodiment is provided with the frame 21 made of resin and including the accommodation spaces 28 and the connectors 20 to be arranged in the accommodation spaces 28. The connector 20 includes the outer conductor 22 made of metal. The outer conductor 22 includes the press-fitting portions 59 and is installed on the upper surface of the board 100. The frame 21 includes the press-fit portions 35, into which the press-fitting portions 59 are press-fit, in the inner surface of the accommodation space 28. The press-fit portions 35 are provided in the lower part below the center in the vertical direction of the frame 21, but not provided in the upper part.

The outer conductor 22 and the frame 21 are held in the assembled state by press-fitting the press-fitting portions 59 of the outer conductor 22 into the press-fit portions 35 of the frame 21. Since the press-fit portions 35 are provided in the lower end part (lower part) capable of suppressing warping deformation during the molding of the frame 21, the height position in the vertical direction can be kept at a fixed position. As a result, the height position of the outer conductor 22 can also be kept at a fixed position, and the outer conductor 22 can be arranged at a proper position on the upper surface of the board 100.

Further, in the case of this embodiment, the inner surface of the accommodation space 28 has the inner side surfaces 29 facing each other in the lateral direction. The press-fit portions 35 are provided in the inner side surfaces 29 of the accommodation space 28. A press-fitting margin (press-fitting depth) of the press-fit portion 35 and the press-fitting portion 59 is facing in the lateral direction. This is preferable in view of the assemblability of the outer conductor 22 with the frame 21.

Further, in the case of this embodiment, the plurality of accommodation spaces 28 are provided in the frame 21. A plurality of types of connectors 20, 20D having differently shaped outer conductors 22 are configured. The press-fitting portions 59 are provided to have the same shape at the same position in each of the plurality of types of connectors 20, 20D. The press-fit portions 35 are provided to have the same shape at the same position in each of the plurality of accommodation spaces 28. According to this, even if the arbitrary connector 20, 20D selected from the plurality of types of connectors 20, 20D is accommodated into any one of the accommodation spaces 28 of the frame 21, the press-fitting portions 59 can be press-fit into the press-fit portions 35 and a variation of forms of use can be expanded.

Furthermore, since each of the frame 21 and the outer conductor 22 is fixed to the board 100 in the case of this embodiment, a relative positional relationship of the frame 21 and the outer conductor 22 is determined via the board 100 and the rattling of the outer conductor 22 with respect to the frame 21 can be prevented.

### Other Embodiments of Disclosure

The above embodiment disclosed this time should be considered illustrative in all aspects, rather than restrictive.

In the case of the above embodiment, three accommodation spaces are provided in the frame. In contrast, according to another embodiment, only one accommodation space may be provided in a frame. In the case of only one accommodation space, the connector is of only one type.

In the case of the above embodiment, the fixing member has a leg shape to be inserted into and soldered to the fixing hole of the board. In contrast, according to another embodiment, a fixing member may have a peg shape to be soldered along an upper surface of a board. Further, according to another embodiment, a frame may be fixed to a board by inserting boss portions projecting from the bottom surface thereof into fixing holes of the board.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector device, comprising:
a frame made of resin and including an accommodation space; and
a connector to be arranged in the accommodation space,
the connector including an outer conductor made of metal,
the outer conductor including a press-fitting portion, the outer conductor being arranged on an upper surface of a board,
the frame including a press-fit portion in an inner surface of the accommodation space, the press-fitting portion being press-fit into the press-fit portion,
the press-fit portion being provided in a lower part below a center in a vertical direction of the frame and not provided in an upper part.

2. The connector device of claim 1, wherein:
the inner surface of the accommodation space has inner side surfaces facing each other in a lateral direction, and
the press-fit portion is provided in the inner side surface and a press-fitting margin of the press-fit portion and the press-fitting portion is provided in the lateral direction.

3. The connector device of claim 1, wherein:
a plurality of the accommodation spaces are provided in the frame,
a plurality of types of the connectors including differently shaped outer conductors are provided,
the press-fitting portion is provided to have the same shape at the same position in each of the plurality of types of connectors, and
the press-fit portion is provided to have the same shape at the same position in each of the plurality of accommodation spaces.

4. The connector device of claim 1, wherein each of the frame and the outer conductor is fixed to the board.
